(19) United States
(12) Patent Application Publication
(10) Pub. No.: US 2025/0029768 A1
(43) Pub. Date: Jan. 23, 2025

(54) COUPLED AND INTEGRATED INDUCTOR AND TRANS-INDUCTOR VOLTAGE REGULATOR

(71) Applicants: HUIZHOU POCO NEW INDUCTOR TECHNOLOGY CO., LTD., Huizhou City (CN); SHENZHEN POCO MAGNETIC CO., LTD., Shenzhen City (CN); HUIZHOU POCO INDUSTRY CO., LTD., Huizhou City (CN); HEYUAN POCO MAGNETIC CO., LTD., Heyuan City (CN)

(72) Inventors: ZHIDA LIU, Shenzhen City (CN); XIONGZHI GUO, Shenzhen City (CN); YUNFAN ZHANG, Shenzhen City (CN)

(21) Appl. No.: 18/772,243

(22) Filed: Jul. 14, 2024

(30) Foreign Application Priority Data
Jul. 17, 2023 (CN) 202321880601.7

(51) Int. Cl. H01F 27/28; G05F 1/32; H01F 27/24

(52) U.S. Cl. CPC H01F 27/28; G05F 1/32; H01F 27/24

(57) ABSTRACT

A coupled and integrated inductor provided in the present invention, includes a magnetic core and one or more conductive coil assembly embedded in the magnetic core; each conductive coil assembly comprises a first conductive coil and a second conductive coil coupled to the first conductive coil. The magnetic core is in close contact with both the first conductive coil and the second conductive coil; the first conductive coil and the second conductive coil pass through the magnetic core side by side, parallel and in close contact with each other, and the first conductive coil and the second conductive coil share a magnetic path. A trans-inductor voltage regulator provided, includes a circuit board and the coupled and integrated inductor electrically connected to the circuit board. The inductor has a coupling coefficient more than 92%, which improves the overall performance of the coupled and integrated inductor.

### CROSS REFERENCE TO RELATED APPLICATIONS

The present invention is 35 U.S.C. § 119 benefit of earlier filing dates; rights of priority of Chinese Applications No. 202321880601.7 filed on Jul. 17, 2023, the disclosure of which is incorporated by reference herein.

### BACKGROUND OF THE INVENTION

### Field of the Invention

The present invention relates to the field of electronic components, and more particularly, to a coupled and integrated inductor.

### Description of Related Art

An inductor is a component that can convert electrical energy into magnetic energy and store it. It is one of the commonly used components in electronic circuits. An inductor generally consists of a magnetic core, one or more conductive coils, packaging materials, etc. With the development of high frequency, high power density, high efficiency and small size of power supplies, various electronic components have been developed. At present, traditional coupled inductors or integrated inductors are difficult to meet the requirements due to their large size, low power density, temperature rise and low coupling coefficient. Therefore, small-sized electronic components with high requirements, high performance and high reliability are necessary and important.

### SUMMARY OF THE INVENTION

An object of the present invention is to is to provide a coupled and integrated inductor to solve the problems of low inductive coupling of existing inductors.

The present invention provides a coupled and integrated inductor, comprises a magnetic core and one or more conductive coil assembly embedded in the magnetic core; each conductive coil assembly comprises a first conductive coil and a second conductive coil coupled to the first conductive coil. The magnetic core is in close contact with both the first conductive coil and the second conductive coil; the first conductive coil and the second conductive coil pass through the magnetic core side by side, parallel and in close contact with each other, and the first conductive coil and the second conductive coil share a magnetic path.

In some embodiments, a distance between the first conductive coil and the second conductive coil is close enough so that the coupling coefficient reaches more than 0.92.

In some embodiments, the first conductive coil is straight and comprise a main body and opposite leads at opposite ends of the main body, the opposite leads of the first conductive coil are exposed on or extend from opposite end surfaces of the magnetic core; the second conductive coil, comprising a main body and opposite leads at opposite sides of the main body, is U-shaped or a Z-shaped or straight; and the opposite leads of the second conductive coil are respectively exposed on the opposite end surfaces of the magnetic core.

In some embodiments, second conductive coil includes a straight main body; the opposite leads are bent from opposite sides of the main body respectively, and exposed on the opposite end surfaces of the magnetic core and one or two adjacent end surfaces; and the straight bodies of the first conductive coil and the second conductive coil are embedded in the magnetic core in parallel and side by side.

In some embodiments, the second conductive coil includes a linear main body; the opposite leads are bent from opposite sides of the main body respectively, and exposed on the opposite end surfaces of the magnetic core and one or two adjacent end surfaces; and the linear bodies of the first conductive coil and the second conductive coil are embedded in the magnetic core in parallel and side by side.

In some embodiments, the first conductive coil and the second conductive coil are parallel to each other.

In some embodiments, the first conductive coil is located outside the second conductive coil, the first conductive coil and the second conductive coil are side by side and closely fitted; and the first conductive coil and the second conductive coil are insulated from each other.

In some embodiments, the first conductive coil and the second conductive coil are separated by a thin insulation layer, whereby the first conductive coil and the second conductive coil are insulated from each other and are close enough.

In some embodiments, surfaces of the first conductive coil and/or the second conductive coil is covered by a thin insulating layer first, and then the magnetic core and the conductive coil is formed by integral molding of the magnetic powder around the first and conductive coils in one mold; or, the first conductive coil and the second conductive coil are side by side and closely fitted to each other by means of filling insulating magnetic powder between the first conductive coil and the second conductive coil to form the thin insulation layer therebetween during the integral molding, whereby the first conductive coil and the second conductive coil are insulated from each other and kept at a sufficiently close distance.

In some embodiments, the end surfaces of the magnetic core with the leads are kept flat.

In some embodiments, the inductor comprise a plurality of conductive coil assembly encapsulated in the magnetic core so as to form a multi-phase coupling inductor; each conductive coil assembly is arranged in parallel and spaced apart from each other; each conductive coil assembly includes the first conductive coil and the second conductive coil, the first conductive coils are electrically connected in series with each other, and the second conductive coils are coupled with and the corresponding first conductive coils respectively.

The present invention provides a trans-inductor voltage regulator, comprising a circuit board, and the coupled and integrated inductor of any of above-described embodiments which is electrically connected to the circuit board.

The advantages of the present invention are:

the integrated inductor of the present application adopts a first conductive coil inserted through the magnetic core and closely fitted to a second conductive coil side by side, and a distance between the first conductive coil and the second conductive coil is close enough to achieve a very high coupling coefficient.

In some embodiments, the integrated inductor of the present application, the magnetic core and the conductive coils are in one-piece, magnetic powder fully fill gaps in the magnetic core and between the conductive coils, which improves the magnetic permeability and magnetic flux density of the inductor, and reduces the power loss. The magnetic core and conductive coils are tightly combined, and have good heat conduction and heat dissipation effects, which can keep the inductor at a lower operating temperature. The magnetic core and conductive coils are molded in one piece to give the inductor a high density.

### BRIEF DESCRIPTION OF DRAWINGS

FIG. 1 illustrates a perspective view of a coupled and integrated inductor in accordance with a first embodiment of the present invention;

FIGS. 2-3 illustrates cross-sectional views of the coupled and integrated inductor in accordance with the first embodiment of the present invention;

FIG. 4 illustrates a perspective view of the coupled and integrated inductor in accordance with a second embodiment of the present invention;

FIGS. 5-6 illustrate cross-sectional views of the coupled and integrated inductor in accordance with the second embodiment of the present invention;

FIG. 7 illustrates a perspective view of the coupled and integrated inductor in accordance with a third embodiment of the present invention;

FIGS. 8-9 illustrate cross-sectional views of the coupled and integrated inductor in accordance with the third embodiment of the present invention;

FIG. 10 illustrates a perspective view of the coupled and integrated inductor in accordance with a fourth embodiment of the present invention; and

FIGS. 11-12 illustrate cross-sectional views of the coupled and integrated inductor in accordance with the fourth embodiment of the present invention.

### DETAILED DESCRIPTION OF THE INVENTION

A coupled and integrated inductor are described herein.

Certain terminology is used in the following description for convenience only and is not limiting. The words “a”, “an” and “one”, as used in the claims and in the corresponding portions of the specification, are defined as including one or more of the referenced items unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. It may be noted that some Figures are shown with partial transparency for the purpose of explanation, illustration and demonstration purposes only, and is not intended to indicate that an element itself would be transparent in its final manufactured form.

Although the terms first, second, etc. may be used herein to describe various elements, components, regions, layers and/or sections; these elements, components, regions, layers and/or sections shall not be referred to as limited by these terms. These terms are only used to distinguish one element, component, region, layer or section from another element, component, region, layer or section. Terms such as “first,” “second,” and other numerical terms when used herein do not imply a sequence or order unless clearly indicated by the context. Thus, an element, component, region, layer or section discussed below could be termed a second element, component, region, layer or section without departing from the teachings of the example embodiments.

For ease of description, orientational terms may be used herein to describe the relationship of one element or feature to another element or feature as shown in the figures, such as “internal”, “external”, “inside”, “outside”, “below”, “beneath”, “under”, “above”, “on”, “top”, “bottom”, “front”, “rear”, “left”, “right”, etc. Such orientational terms are intended to encompass different orientations of the device in use or operation in addition to the orientation depicted in the figures. For example, if the device in the figures is turned over, elements described as “below” or “beneath” or “under” other elements or features would then be oriented “above” or “on” the other elements or features. Thus, the example term “below” may include an orientation of above and below. The device may be otherwise oriented (rotated 90 degrees or at other orientations) and the orientation herein should be interpreted accordingly.

The experimental methods described in the following examples, if no special limitations are given, are conventional methods; the reagents and materials, if no special limitations are given, can be obtained from commercial sources.

The endpoints and any values disclosed herein are not limited to the precise ranges or values, but these ranges or values should be understood to include values approaching these ranges or values. For numerical ranges, the endpoint values of each range, the endpoint values of each range and individual point values within the range, and the individual point values can be combined with each other to obtain one or more new numerical ranges. These numerical ranges shall be deemed to be specifically disclosed herein.

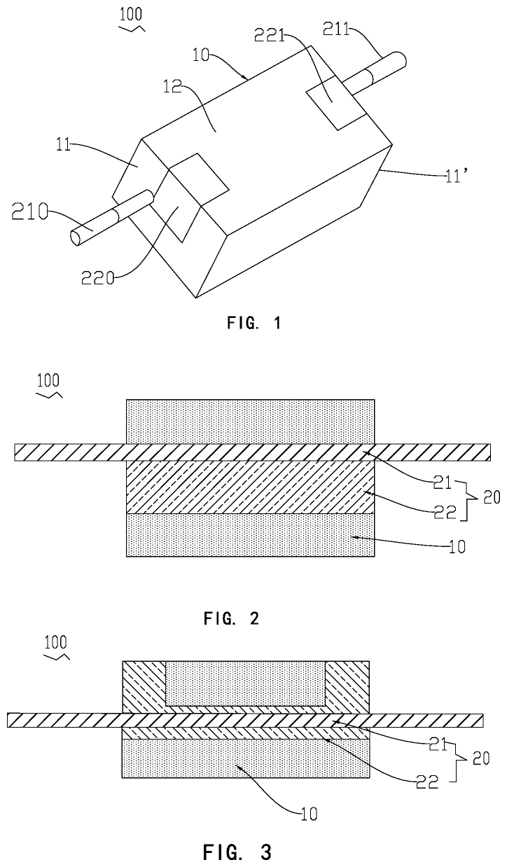

Referring to FIGS. 1-12, a coupled and integrated inductor 100 of the present invention includes a magnetic core 10 and one or more coupled conductive coil assembly 20 inside the magnetic core 10. The coupled and integrated inductor 100 can be single-phase coupled or multi-phase coupled, where the single-phase inductor has one or more pair of conductive coils in the magnetic core 10, and the multi-phase inductor has multiple pair of conductive coils in the magnetic core 10. Each conductive coil assembly 20 includes a first conductive coils 21 and a second conductive coils 22 which are coupled to each other. The first conductive coil 21 and the second conductive coil 22 pass through the magnetic core 10 side by side and closely fit to each other. The first conductive coil 21 and the second conductive coil 22 share the magnetic path. The first conductive coil 21 and the second conductive coil 22 are close enough and have the same magnetic path, so the coupling coefficient is as high as 0.92 or more, which improves the overall performance of the coupled inductor 100.

The surface of the conductive coil 21, 22 or between the conductive coils 21, 22 is provided with a thin insulating layer or magnetic powder to ensure insulation between the inductors 21, 22 to improve the reliability of the inductor 100. In one exemplary embodiment, the surface of the first conductive coil 21 and/or the second conductive coil 22 is covered with a thin insulating layer to insulate the first conductive coil 21 and the second conductive coil 22 from each other. The thin insulating layer covers the first conductive coil 21 and the second conductive coil, which provides a sufficiently close distance between the first conductive coil 21 and the second conductive coil 22, the magnetic path of the first conductive coil 21 and the second conductive coil 22 is the same, and the coupling coefficient therebetween is above 0.92. In another exemplary embodiment, during one-piece molding (or an integral molding) method, magnetic powder fill between the first conductive coil 21 and the second conductive coil 22 to insulate the first conductive coil 21 and the second conductive coil 22, and provide a distance close enough so that the first conductive coil 21 and the second conductive coil 22 has the same magnetic path, and the coupling coefficient reaches more than 0.92.

In some embodiments, the first conductive coil 21, comprise a main body and opposite leads 210, 211, and is in a straight-out shape (straight line shape), namely, the first conductive coil 21 is a straight coil. The first conductive coil 21 passes through the magnetic core 10 with it opposite leads 210, 211 penetrating and exposed on the opposite end surfaces 11, 11′ of the magnetic core 10. The opposite leads 210, 211 of the first conductive coil 21 extend outward from the opposite end surfaces 11 and 11′ to facilitate connection with an external circuit.

The second conductive coil 22 with its opposite leads 220, 221 is U-shaped or Z-shaped or are straight-out as a whole. The U-shaped or Z-shaped conductive coil 22 includes a straight main body and opposite bent leads 220 and 221. In some embodiments, the second conductive coil 22 passes through the magnetic core 10 with its opposite leads 221 and 220 exposed on the opposite end surfaces 11/11′ of the magnetic core 10 or exposed on two pairs of opposite surfaces 11/11′ and 12/12′ of the magnetic core 10 to facilitate connection with an external circuit. Preferably, the two leads 220 and 221 are flush with the surfaces of the magnetic core 10 to keep the surfaces of the magnetic core 10 uniformly flat. When the second conductive coil 22 is a straight-out conductive coil (namely a straight coil), it passes through the magnetic core 10 with its opposite leads 220, 221 penetrating and exposed on the opposite end surfaces 11, 11′ of the magnetic core 10; and the first conductive coil 21 and the second conductive coil 22 are in contact side by side and are parallel to each other.

The linear main bodies of the first conductive coil 21 and the second conductive coil 22 are arranged side by side in parallel and closely fitted. The fitting surfaces are filled with the above-mentioned thin insulating layer or magnetic powder so that the first conductive coil 21 and the second conductive coil 22 are insulated from each other and keep close enough.

In some embodiments, the one-piece (integrated) inductor 100 is multi-phase coupled and integrated, and a multi-phase coupled conductive coil assembly 20 is embedded in the magnetic core 10. Each conductive coil assembly 20 includes the above-mentioned coupled first conductive coil 21 and second conductive coil 22. The multi-phase coupled conductive coil assembly 20 are arranged in parallel and spaced apart from each other, and the first conductive coils 21 and the second conductive coils 22 are correspondingly parallel to each other. In the multi-phase coupled inductor, the first conductive coils 21 are connected in series with each other, and the second conductive coils 22 are highly coupled to the corresponding first conductive coils 21 respectively, thereby the inductor obtains a high dynamic response.

In some embodiments, a cross-sectional shape of the first conductive coil 21 and the second conductive coil 22 may be square, rectangle, circle, ellipse, triangle, etc.

The inductor 100 can be a single-phase or multi-phase coupled and integrated to save volume and obtain high power density. In one exemplary embodiment, the magnetic core 10 and the conductive coil assembly 20 can be formed into an integrated structure by means of molding by filling magnetic powder into a mold with the conductive coil assembly 20 installed therein. The molding process is as follows:
Pressing and molding step: installing conductive coil assembly 20 in the mold where the first conductive coil 21 and the second conductive coil 22 are installed side by side and closely in the mold cavity, filling the mold cavity with magnetic powder, applying pressure for molding, where the molding pressure can be 12˜24 T/cm², then obtaining a raw inductor of which the conductive coils are buried in the magnetic core and the leads of the conductive coils are exposed on the surface(s) of the magnetic core; and
annealing step: placing the raw inductor in a heat treatment furnace for calcinating and annealing so as to release residual stress inside the magnetic core, and obtaining the integrated inductor with the high dynamic response, where annealing temperature can be 400˜850° C.

The soft magnetic powder adopts insulating magnetic powder, and the insulating magnetic powder can be one or more of Fe-base powder, such as Fe-powder, Fe—Si powder, Fe—Si—Al alloy powder, Fe—Ni alloy powder, etc. The soft magnetic powder can also be Fe-based amorphous powder.

In one embodiment of the present invention, the coupled and integrated inductor 100 is a molded inductor, which is manufactured by means of pressing or molding magnetic powder (namely magnetic particles) in a mold around the conductive coils. The magnetic core 10 and the conductive coils 21, 22 are closely fitted and fully contacted, thus heat of the conductive coils 21, 22 can be quickly conducted to and dissipated through the magnetic core 10, the heat dissipation effect is good, and a temperature rise of the inductor is reduced. Therefore, compared with traditional inductors, the coupled and integrated inductor 100 of the present application has the advantages of higher density, smaller volume, higher inductance, and lower temperature rise, which can improve the overall performance of the inductor. The molding process at a high-pressure (12˜24 T/cm²) significantly reduces gaps inside the inductor (or inside magnetic core), through which an inductor can be obtained with full space utilization and at a high-power density.

Referring to FIGS. 1-3, the coupled and integrated inductor 100 in accordance with a first embodiment of the present invention, includes a square (not limited to square) magnetic core 10, and a conductive coil assembly 20 are embedded in the magnetic core 10. The conductive coil assembly 20 includes a first conductive coil 21 and a second conductive coil 22 that are coupled to each other. The first conductive coil 21 is a straight-out (linear) conductive coil and closely fits side by side with the second conductive coil 22. The first conductive coil 21 is inserted into a straight-through hole in the magnetic core 10. Two leads 211 and 210 of the firsts conductive coil 21 protrude from the opposite surfaces 11 and 11′ of the magnetic core 10, respectively. The second conductive coil 22 with two leads 220 and 221 are U-shaped as a whole, and a main body of the second conductive coil 22 is linear. The second conductive coil 22 passes through the magnetic core 10 and its leads 220, 221 are exposed on the two opposite end surfaces 11 and 11′. For example, one lead 220 of the second conductive coil 22 is bent and placed in a communicated groove in the adjacent two end surfaces 11 and 12 of the magnetic core 10, and the other lead 221 is bent and placed in a communicated groove in the adjacent two end surfaces 11′ and 12 of the magnetic core 10, where the end surfaces 11, 11′ are opposite to each other. The leads 220 and 221 are placed or embedded in the end surface and exposed on the end surfaces of the magnetic core 10 while keep the end surfaces flat. Conductive coating may be provided to cover and electrically connected with the leads 220, 221 which are exposed on the end surfaces 11/11′ and/or 12 of the magnetic core 10. The gap between the first conductive coil 21 and the second conductive coil 22 is filled with magnetic powder (particles) to form a thin insulating layer. By in-mold molding of the magnetic powder and the conductive coils 21 and 22, the insulating magnetic powder (particles) material is evenly distributed between the conductive coils, so that the closest distance can be obtained between the conductive coils 21 and 22 while the conductive coils 21 and 22 are electrically insulated from each other, and there is almost no gap inside the inductor 100 (or inside the magnetic core 10). The first conductive coil 21 and the second conductive coil 22 pass through the magnetic core 10 side by side in parallel and closely fitting. The first conductive coil 21 and the second conductive coil 22 share their magnetic path, and the coupling coefficient therebetween can be 0.92 or above. In other embodiments, the surfaces of the first conductive coil 21 and/or the second conductive coil 20 are covered with a thin insulation layer to insulate the first conductive coil 21 and the second conductive coil 22.

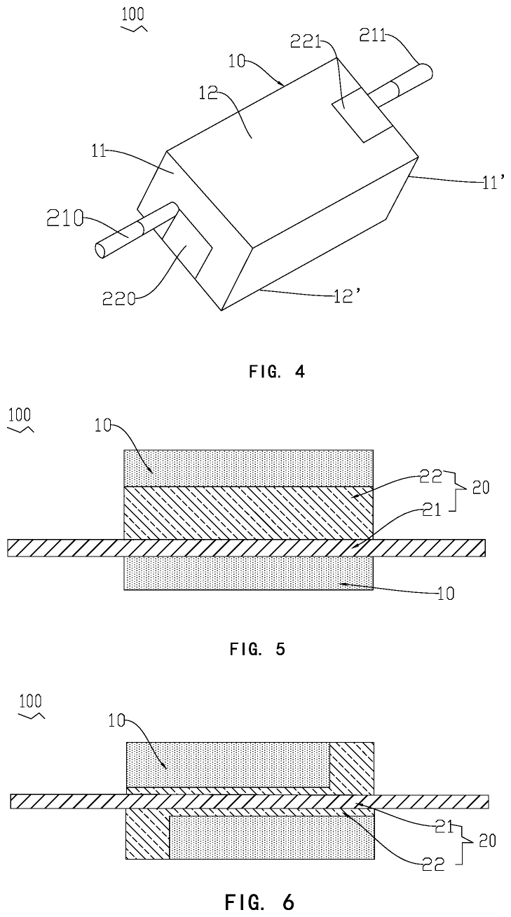

Referring to FIGS. 4-6, the coupled and integrated inductor 100 in accordance with a second embodiment of the present invention, includes the square (not limited to square) magnetic core 10, and the conductive coil assembly 20 are embedded in the magnetic core 10. The conductive coil assembly 20 includes the first conductive coil 21 and the second conductive coil 22 that are coupled to each other. The first conductive coil 21 is a straight-out (or linear or straight) conductive coil and closely fits side by side with the second conductive coil 22. The first conductive coil 21 is inserted into the straight-through hole in the magnetic core 10. Two leads 211 and 210 of the first conductive coil 21 extend out of the opposite surfaces 11 and 11′ of the magnetic core 10 to electrically connect with an external circuit. The second conductive coil 22 comprises a main body and two leads 220 and 221 from the main body, and is Z-shaped, where the main body of the second conductive coil 22 is linear (straight). The second conductive coil 22 passes through the magnetic core 10 and its leads 220 and 221 are exposed on the two opposite end surfaces 11 and 11′ of the magnetic core 10. In an exemplary embodiment, one lead 220 of the second conductive coil 22 is bent and placed (or embedded) in a communicated groove in the adjacent two end surfaces 11 and 12′ of the magnetic core, and the other lead 221 is bent and placed (or embedded) in the adjacent two end surfaces 11′ and 12 of the magnetic core 10. The end surfaces 11 and 11′ are opposite to each other, and the end surfaces 12 and 12′ are opposite to each other. The leads 220 and 221 extend in and are exposed on the end surfaces 11/11′ and 12/12′ of the magnetic core 10, while keep the end surfaces flat. Conductive coating can be provided to cover and electrically connect with the leads 220 and 221 which are exposed on the end surfaces 11/11′ and/or 12/12′ of the magnetic core, thereby, an electrical connection between the inductor 100 and an external circuit is facilitated. The spacing or gap between the first conductive coil 21 and the second conductive coil 22 is filled with a thin insulating layer formed by soft magnetic powder (soft magnetic particles). Through the in-mold molding of the magnetic powder and the conductive coils 21 and 22, the insulating magnetic powder material is evenly distributed between the conductive coils 21 and 22, thereby, a distance between the first conductive coil 21 and the second conductive coil 22 is the closest but they are electrically insulated from each other, and there is almost no gap/space inside the inductor 100 (or inside the magnetic core 10). The first conductive coil 21 and the second conductive coil 22 pass through the magnetic core 10 side by side in parallel and closely fitted to each other. The first conductive coil 21 and the second conductive coil 22 share the same magnetic path, and the coupling coefficient therebetween is 0.92 or above. In other embodiments, the surfaces of the first conductive coil 21 and/or the second conductive coil 20 are covered with a thin insulation layer to insulate the first conductive coil 21 from the second conductive coil 22.

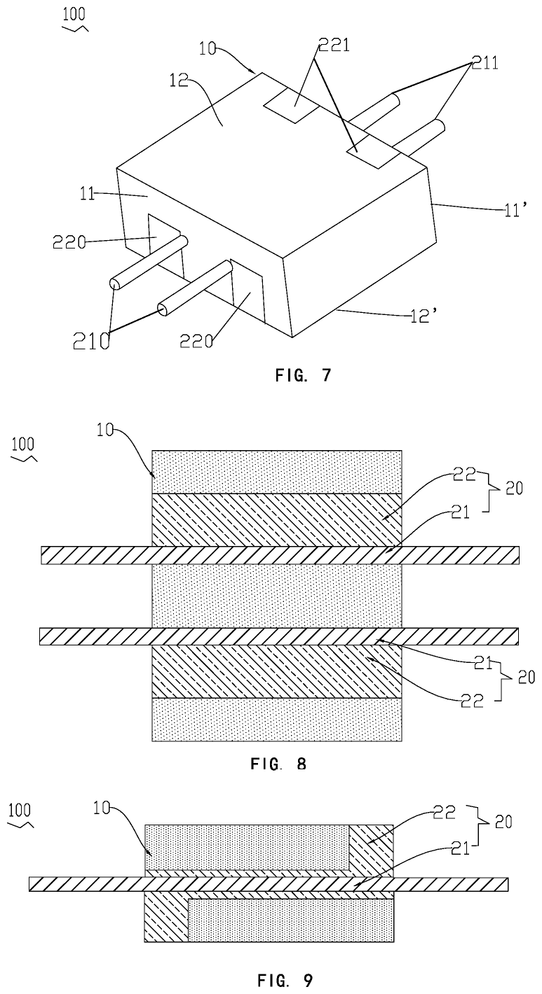

Referring to FIGS. 7-9, the coupled and integrated inductor 100 in accordance with a third embodiment, includes the square (not limited to square) magnetic core 10, and multiple conductive coil assembly 20 embedded in the magnetic core 10 to form a multi-phase coupling inductor. In an exemplary embodiment, two conductive coil assemblies 20 are arranged in parallel and spaced apart in the magnetic core 10. Each conductive coil assembly 20 includes the first conductive coil 21 and the second conductive coil 22, and each first conductive coil 21 and second conductive coil 22 are parallel respectively. The second conductive coil 22, comprising a main body and opposite leads 220 and 221, is Z-shaped as a whole, where the main body of the second conductive coil 22 is linear (or straight). The second conductive coil 22 passes through the magnetic core 10 and its leads 220, 221 are exposed on the opposite end surfaces 11 and 11′ of the magnetic core 10. On an exemplary embodiment, one lead 220 bent from the main body of the second conductive coil 22 extends to and is exposed on the adjacent two end surfaces 11 and 12′ of the magnetic core, and the other lead 221 bent from the main body of the second conductive coil 22 extends to and is exposed on the adjacent two end surfaces 11′ and 12 of the magnetic core 10. The end surfaces 11 and 11′ are opposite to each other, and the end surfaces 12 and 12′ are opposite to each other. The leads 220 and 221 are embedded in the end surfaces 11/11′ and 12/12′, and their outer walls are exposed on the end surfaces and keep the end surfaces flat. The leads 220 and 221 can be covered with conductive coating on the end surfaces 11/11′ and/or 12/12′ of the magnetic core 10 for facilitating electrical connection with a circuit board. The first conductive coil 21, as a straight-out (or linear or straight) conductive coil, along its length direction, passes through the magnetic core 10, and is parallel to the second conductive coil 22. The opposite leads 211 and 210 of the first conductive coil 21 extend out of the opposite surfaces 11 and 11′ of the magnetic core 10 and are electrically connected to a circuit on a circuit board. The straight first conductive coil 21 and the Z-shaped second conductive coil 22 are closely fitted to each other and extend side by side through the magnetic core 10, and a thin insulation layer between the conductive coils 21 and 22 is formed by filling magnetic powder between the fitted surfaces of the conductive coils 21 and 22. By in-mold molding of the magnetic powder and the conductive coils 21 and 22, the insulating magnetic powder (particles) material is evenly distributed between the conductive coils, so that the closest distance can be obtained between the conductive coils 21 and 22 while the conductive coils 21 and 22 are electrically insulated from each other, and there is almost no gap inside the inductor 100 (or inside the magnetic core 10). The first conductive coil 21 and the second conductive coil 22 share their magnetic path, and the coupling coefficient therebetween can be 0.92 or above. In other embodiments, the surfaces of the first conductive coil 21 and/or the second conductive coil 22 are covered with a thin insulating layer, so that the first conductive coil 21 and the second conductive coil 22 pass through the magnetic core 10 side by side in parallel and closely fitted to each other, and are insulated from each other.

This embodiment takes two-phase coupling as an example to illustrate the principle of multi-phase coupling, which can realize series connection between each first conductive coils 21, and the second conductive coils 22 are highly coupled with the corresponding first conductive coils 21 respectively, thus a high response of the inductor 100 is obtained.

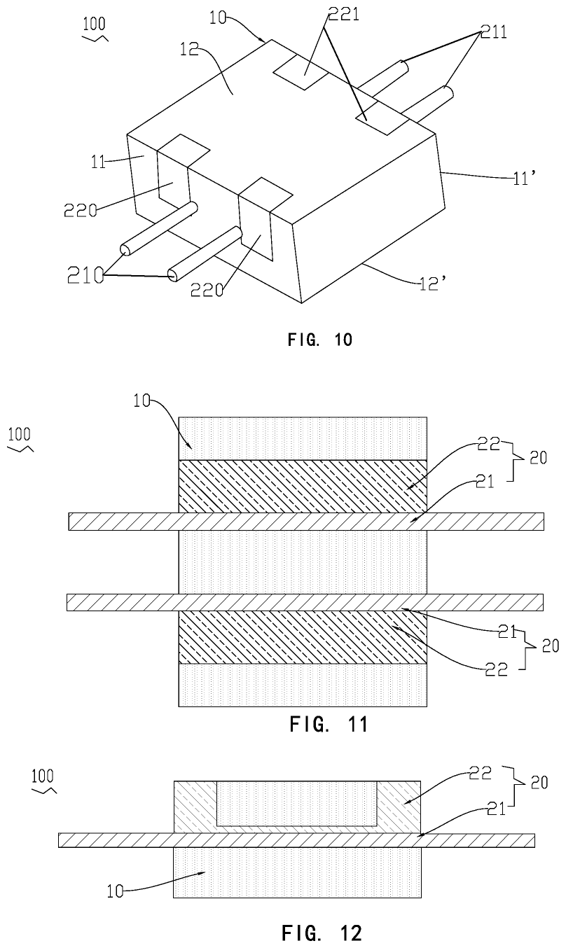

Referring to FIGS. 10-12, the coupled and integrated inductor 100 of the fourth embodiment includes the square (not limited to square) magnetic core 10, and multiple conductive coil assemblies 20 embedded in the magnetic core 10 to form a multi-phase coupling inductor. As shown in the figures, two conductive coil assemblies 20 are arranged in parallel and spaced apart in the magnetic core 10. Each conductive coil assembly 20 includes the first conductive coil 21 and the second conductive coil 22, and each first conductive coil 21 and second conductive coil 22 are parallel respectively. The second conductive coil 22, comprising a main body and opposite leads 220 and 221, is U-shaped as a whole, where the main body of the second conductive coil 22 is linear or straight. The second conductive coil 22 passes through the magnetic core 10 with its opposite leads 210 and 220 exposed on the opposite end surfaces 11 and 11′ of the magnetic core 10. In an exemplary embodiment, the lead 220 bent from one side of the main body, is embedded in a communicated groove in the adjacent two end surfaces 11 and 12 of the magnetic core 10, and the other lead 221 bent from the other side of the main body, is embedded in a communicated groove in the adjacent two end surfaces 11′ and 12 of the magnetic core 10. The end surfaces 11 and 11′ are the opposite to each other. The leads 220 and 221 extend in the end surfaces, and their outer walls are exposed on the end surfaces and keep the end surfaces flat. The leads 220 and 221 may be covered and electrically connected with a conductive coating on the end surfaces 11/11′ and/or 12 of the magnetic core 10 to electrically connect with an external circuit in a circuit board. The first conductive coil 21 is straight-out or straight or linear, and parallel to the second conductive coil 22 along the length direction, and passes through the magnetic core 10. Its two leads 211 and 210 extend out of the opposite surfaces 11 and 11′ of the magnetic core 10 and are electrically connected to the external circuit. The straight-out first conductive coil 21 and the U-shaped second conductive coil 22 are closely fitted side by side, and a thin insulation layer is formed between the fitted surfaces by means of filling magnetic powder (particles) therebetween. By in-mold molding of the magnetic powder and the conductive coils 21 and 22, the insulating magnetic powder (particles) material is evenly distributed between the conductive coils, so that the closest distance can be obtained between the conductive coils 21 and 22 while the conductive coils 21 and 22 are electrically insulated from each other, and there is almost no gap inside the inductor 100 (or inside the magnetic core 10). and the first conductive coil 21 and the second conductive coil 22 share the magnetic path. The first conductive coil 21 and the second conductive coil 22 share their magnetic path, and the coupling coefficient therebetween can be 0.92 or above. In other embodiments, the surface of the first conductive coil 21 and/or the second conductive coil 22 is covered with a thin insulating layer, and then each conductive coil is placed into the mold cavity and co-molding with the magnetic powder (particles) to be integrally formed, so that the first conductive coil 21 and the second conductive coil 22 are insulated from each other.

The fourth embodiment also takes two-phase coupling as an example to illustrate the principle of multi-phase coupling, which can realize series connection between each first conductive coils 21, and the second conductive coils 22 are highly coupled with the corresponding first conductive coils 21 respectively, thus a high response of the inductor 100 is obtained.

The coupled and integrated inductor 100 of the present application is used as an inductor for a trans-inductor voltage regulator (TLVR). The TLVR comprise a circuit board, and the inductor 100 is electrically connected with a circuit in the circuit board.

In the one-piece inductor 100 of the present application, one or more conductive coil assembly 20 are embedded in the magnetic core 10. The straight-out first conductive coil 21 and the U-shaped or Z-shaped second conductive coil 22 of each conductive coil assembly 20 are side by side in parallel and closely fitted to each other. The first and second conductive coils 21, 22 are insulated and spaced close enough to share their magnetic path to obtain a high coupling coefficient, and the coupling coefficient can be 0.92 or above. Through high-pressure molding of soft magnetic powder (particles) and conductive coils in one mold, the insulating magnetic powder (particle) material is evenly distributed between the conductive coils, thereby, the first conductive coil 21 and the second conductive coil 22 are spaced at the closest distance and are insulated from each other. There is almost no gap/spacing inside the entire inductor 100 (or magnetic core 10) to obtain full space utilization and high-power density. The magnet core 10 and conductive coils 21, 22 are fully contacted and closely combined to realize rapid heat transfer and good heat dissipation effect, which keeps the inductor at a lower operating temperature. The inductor 100 of the present invention is simpler for manufacturing and applicable for SMD packaging, therefore, it is easy to realize an automagical manufacturing process, and the manufacturing method for the inductor and the inductor are low-cost. The coupled and integrated inductor of the present invention can be integrated with single or multiple phase to obtain a small size with high power density. The inductor in accordance with some embodiments of the present invention is formed by integrating the magnetic core made of soft magnetic power (particles) and conductive coils in one mold, the entire closed magnetic path of the inductor is provided by the magnetic materials, and there is no obvious air gap in the inductor or in the magnetic core; therefore, the integrated inductor provided by the present invention obtains magnetic shield, which represents an anti-electromagnetic interference function.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. A coupled and integrated inductor, comprising:
a magnetic core; and
one or more conductive coil assembly embedded in the magnetic core, each conductive coil assembly comprising:
a first conductive coil; and
a second conductive coil coupled to the first conductive coil;
wherein the magnetic core is in close contact with both the first conductive coil and the second conductive coil; the first conductive coil and the second conductive coil pass through the magnetic core side by side, parallel and in close contact with each other, and the first conductive coil and the second conductive coil share a magnetic path.

2. The inductor as claimed in claim 1, wherein a distance between the first conductive coil and the second conductive coil is close enough so that the coupling coefficient reaches more than 0.92.

3. The inductor as claimed in claim 1, wherein the first conductive coil is straight and comprise a main body and opposite leads at opposite ends of the main body, the opposite leads of the first conductive coil are exposed on or extend from opposite end surfaces of the magnetic core; the second conductive coil, comprising a main body and opposite leads at opposite sides of the main body, is U-shaped or a Z-shaped or straight; and the opposite leads of the second conductive coil are respectively exposed on the opposite end surfaces of the magnetic core.

4. The inductor as claimed in claim 3, wherein the second conductive coil includes a linear main body; the opposite leads are bent from opposite sides of the main body respectively, and exposed on the opposite end surfaces of the magnetic core and one or two adjacent end surfaces; and the linear bodies of the first conductive coil and the second conductive coil are embedded in the magnetic core in parallel and side by side.

5. The inductor as claimed in claim 1, wherein the first conductive coil and the second conductive coil are parallel to each other.

6. The inductor as claimed in claim 1, wherein the first conductive coil is located outside the second conductive coil, the first conductive coil and the second conductive coil are side by side and closely fitted; and the first conductive coil and the second conductive coil are insulated from each other.

7. The inductor as claimed in claim 6, wherein the first conductive coil and the second conductive coil are separated by a thin insulation layer, whereby the first conductive coil and the second conductive coil are insulated from each other and are close enough.

8. The inductor as claimed in claim 7, wherein surfaces of the first conductive coil and/or the second conductive coil is covered by a thin insulating layer first, and then the magnetic core and the conductive coil is formed by integral molding of the magnetic powder around the first and conductive coils in one mold; or,
the first conductive coil and the second conductive coil are side by side and closely fitted to each other by means of filling insulating magnetic powder between the first conductive coil and the second conductive coil to form the thin insulation layer therebetween during the integral molding, whereby the first conductive coil and the second conductive coil are insulated from each other and kept at a sufficiently close distance.

9. The inductor as claimed in claim 3, wherein the end surfaces of the magnetic core with the leads are kept flat.

10. The inductor as claimed in claim 1, wherein the inductor comprise a plurality of conductive coil assembly encapsulated in the magnetic core so as to form a multi-phase coupling inductor; each conductive coil assembly is arranged in parallel and spaced apart from each other; each conductive coil assembly includes the first conductive coil and the second conductive coil, the first conductive coils are electrically connected in series with each other, and the second conductive coils are coupled with and the corresponding first conductive coils respectively.

11. A trans-inductor voltage regulator, comprising:
a circuit board; and
a coupled and integrated inductor electrically connected to the circuit board, the coupled and integrated inductor comprising:
a magnetic core; and
one or more conductive coil assembly embedded in the magnetic core, each conductive coil assembly comprising:
a first conductive coil; and
a second conductive coil coupled to the first conductive coil;
wherein the magnetic core is in close contact with both the first conductive coil and the second conductive coil; the first conductive coil and the second conductive coil pass through the magnetic core side by side, parallel and in close contact with each other, and the first conductive coil and the second conductive coil share a magnetic path.

12. The trans-inductor voltage regulator as claimed in claim 11, wherein a distance between the first conductive coil and the second conductive coil is close enough so that the coupling coefficient reaches more than 0.92.

13. The trans-inductor voltage regulator as claimed in claim 11, wherein the first conductive coil is straight and comprise a main body and opposite leads at opposite ends of the main body, the opposite leads of the first conductive coil are exposed on or extend from opposite end surfaces of the magnetic core; the second conductive coil, comprising a main body and opposite leads at opposite sides of the main body, is U-shaped or a Z-shaped or straight; and the opposite leads of the second conductive coil are respectively exposed on the opposite end surfaces of the magnetic core.
